(19) United States
(12) Patent Application Publication
(10) Pub. No.: US 2018/0137523 A1
(43) Pub. Date: May 17, 2018

(54) MIRROR SYSTEM AND METHOD ENABLING PHOTO AND VIDEO SHARING BY MEANS OF BIDIRECTIONAL COMMUNICATION

(71) Applicant: STYLEMIRROR CO., LTD., Seoul (KR)

(72) Inventors: Heejung KIM, Seoul (KR); Sangseong LEE, Seoul (KR)

(21) Appl. No.: 15/572,630

(22) PCT Filed: Apr. 22, 2016
(86) PCT No.: PCT/KR2016/004232

§ 371 Date: Nov. 8, 2017

(30) Foreign Application Priority Data
May 8, 2015 (KR) 10-2015-0064264
Jun. 3, 2015 (KR) 10-2015-0078305

(51) Int. Cl. G06Q 30/02; G06Q 50/00; G06Q 30/06; G06K 7/10; H04L 29/08; G02B 5/08; G02B 27/00; H04N 5/225; H04N 5/232; H04N 5/77

(52) U.S. Cl. CPC G06Q 30/0201; G06Q 50/01; G06Q 30/0625; G06K 7/10366; H04L 67/22; G06F 3/165; G02B 27/0093; H04N 5/2257; H04N 5/23293; H04N 5/77; H04L 67/12; G02B 5/08

(57) ABSTRACT

A mirror system and method which is capable of sharing photos and videos by bidirectional communication may be provided. A photo or video of clothes worn by the user, which is obtained by the fact that user's figure reflected in a translucent display mirror capable of interacting with a smartphone on the basis of an Internet of Things (IoT) network is photographed as it is in real time, is transmitted as it is to the smartphone. Also, the clothes product worn by the user can be purchased by the smartphone after the user leaves the store and the store can expect sales from the customer who left the store. A photo or a video photographed by a camera embedded in the smart device or style mirror is stored in a server and is simultaneously transmitted to a store terminal and the user's smartphone. Photos or videos can be shared through social network services (SNS). The photographing can be performed according to the user's requests by the combination of the camera, proximity sensor, beacon sensor and by controlling the photo or video photographing moment by a controller.

### TECHNICAL FIELD

The present invention relates to a mirror system and method which is capable of sharing photos and videos by bidirectional communication and has a wide range of application. According to the present invention, a photo or video of clothes worn by the user, which is obtained by the fact that user's figure reflected in a translucent display mirror capable of interacting with a smartphone on the basis of an Internet of Things (IoT) network is photographed as it is in real time, is transmitted as it is to the smartphone. Also, the clothes product worn by the user can be purchased by the smartphone after the user leaves the store and the store can expect sales from the customer who left the store. When the user stands before a style mirror or a smart device selected from among the smartphone, tablet PC, and camera, a user's smartphone application and the style mirror or a smart device application are driven by a beacon sensor for indoor location tracking. Natural photographing can be performed according to the user's requests by the style mirror or smart device application. A photo at which the photographing is performed by a camera embedded in the smart device or style mirror or a video photographed by the camera embedded in the smart device or style mirror is stored in a server and is simultaneously transmitted to a store terminal and the user's smartphone. Photos or videos can be shared through social network services (SNS). The photographing can be performed according to the user's requests by the combination of the camera, proximity sensor, beacon sensor and by controlling the photo or video photographing moment by a controller. A message which helps the user photographing may be output as an image and a voice by a display unit and an audio output unit within the smart device or style mirror. The smart device is combined with an angle-adjustable Jabara type holder and then is used with being attached to a typical minor, so that the user's figure reflected in the mirror can be photographed as it is in real time regardless of the angle and position. The mirror system and method can be applied to industry fields including clothes or beauty.

### BACKGROUND ART

According to Korean Laid-open Utility Application No. 2009-0011579 (Nov. 12, 2009), not only with the increase of various types of information communication terminals but with the advancement of information communication technology, a very large amount of information is unilaterally provided to users. The user increasingly tends to obtain user-oriented information in various spaces anytime regardless of a place and time that the user wants.

Therefore, there is an increasing demand for a device which provides only selected useful user-centric information instead of existing fragmentary information unilaterally provided. In particular, due to the unilateral information display oriented method based on the existing unidirectional information transmission, there is a difficulty in displaying the user-centric information and there is a limit to display the information.

In general, an information transmission device included in a large-sized multi-display device having a multi-screen has mainly a unilateral video-centric information display type. Only the unilateral information is transmitted by displaying simple images or multimedia videos on a large-sized screen, and the user simply sees the information accordingly. Therefore, it is difficult to provide a variety of user's requirement-centric information and difficult to create and display various user-oriented contents.

Meanwhile, the conventional technology does not have a system in which the photo of clothes worn by the user, which is obtained by the fact that the user's figure reflected in the mirror is photographed as it is in real time, is transmitted to the smartphone, or does not have a system to which, after the user leaves the use location (store), the user is connected in an online commerce way. Therefore, it is difficult to purchase.

Therefore, there is an urgent requirement for the development of a mirror system and method which is capable of sharing the photos and videos by bidirectional communication. The mirror system and method has the following characteristics. When the user stands before the style mirror or smart device selected from among the smartphone, tablet PC, and camera, the user's smartphone application and style mirror or smart device application are driven by the beacon sensor for indoor location tracking. Natural photographing can be performed according to the user's requests by the style mirror or smart device application. The photo or video photographed by the camera embedded in the smart device or style mirror is stored in a server and is simultaneously transmitted to a store terminal and the user's smartphone. Photos or videos can be shared through social network services (SNS). The smart device is combined with an angle-adjustable Jabara type holder and then is used with being attached to a typical mirror, so that the user's figure reflected in the mirror can be photographed as it is in real time regardless of the angle and position. Also, the clothes product worn by the user can be purchased by the smartphone.

### DISCLOSURE

### Technical Problem

Accordingly, the present invention is designed to solve the above problems. An object of the present invention is to provide a mirror system and method which is capable of sharing photos and videos by bidirectional communication and has a wide range of application. According to the mirror system and method, a photo or video of clothes worn by the user, which is obtained by the fact that user's figure reflected in a translucent display mirror capable of interacting with a smartphone on the basis of an Internet of Things (IoT) network is photographed as it is in real time, is transmitted as it is to the smartphone. Also, the clothes product worn by the user can be purchased by the smartphone after the user leaves the store and the store can expect sales from the customer who left the store.

Another object of the present invention is to provide a mirror system and method which is capable of sharing photos and videos by bidirectional communication. According to the mirror system and method, when the user stands before a style mirror or a smart device selected from among the smartphone, tablet PC, and camera, a user's smartphone application and the style mirror or a smart device application are driven by a beacon sensor for indoor location tracking. Natural photographing can be performed according to the user's requests by the style mirror or smart device application.

Further another object of the present invention is to provide a mirror system and method which is capable of sharing photos and videos by bidirectional communication. According to the mirror system and method, the photo or video photographed by the camera embedded in the smart device or style mirror is stored in a server and is simultaneously transmitted to a store terminal and the user's smartphone. Photos or videos can be shared through social network services (SNS).

Yet another object of the present invention is to provide a mirror system and method which is capable of sharing photos and videos by bidirectional communication. According to the mirror system and method, the photographing can be performed according to the user's requests by the combination of the camera, proximity sensor, beacon sensor and by controlling the photo or video photographing moment by a controller.

Still another object of the present invention is to provide a mirror system and method which is capable of sharing photos and videos by bidirectional communication. According to the mirror system and method, a message which helps the user photographing may be output as an image and a voice by a display unit and an audio output unit within the smart device or style mirror.

Still another object of the present invention is to provide a mirror system and method which is capable of sharing photos and videos by bidirectional communication. According to the mirror system and method, the smart device is combined with an angle-adjustable Jabara type holder and then is used with being attached to a typical mirror, so that the user's figure reflected in the mirror can be photographed as it is in real time regardless of the angle and position.

Still another object of the present invention is to provide a mirror system and method which is capable of sharing photos and videos by bidirectional communication and has a wide range of application. The mirror system and method can be applied to industry fields including clothes or beauty.

### Technical Solution

One embodiment of the present invention which is designed to achieve the above objects of the present invention is a mirror system capable of sharing photos and videos by bidirectional communication. The mirror system includes: a user location and information recognition unit which has a function of recognizing a user location and personal information by driving a user's smartphone application, a style mirror or a smart device application by a beacon sensor for indoor location tracking; a style mirror or smart device which includes: an audio output unit which has a function of broadcasting an execution process of an application of the style mirror or smart device, a situation recognition unit which has a function of recognizing a situation of the user by a proximity sensor after the application is started and has a function of photographing photos or videos, a camera unit which has a function of photographing user's figure by a signal of the situation recognition unit, a display unit which displays the user's figure photographed by the camera unit and an information message on a screen of the smart device or the style mirror, and a control unit which has a function of controlling the operation of the audio output unit, the situation recognition unit, the camera unit, and the display unit and has a function of communicating with the user location and information recognition unit via Bluetooth communication; a network which has a function of connecting a server and the style mirror or smart device via Wifi, wired communication or wireless data communication; a server which includes: a content storage unit which is connected to the style mirror or smart device by the network and has a function of storing contents of an image or video, a social network service (SNS) unit which has a function of sharing the image or video and various activities with a store terminal and a user terminal through social network services (SNS), a function of managing and supporting a comprehensive database including the user, photo, video, product, transaction information, a function of collecting and analyzing the activities of the social network service (SNS) unit and data generated from business transactions, a function of issuing a marketing report, and a function of storing the image or video; and a user terminal (smartphone) which has a function of receiving the photo or video stored in the server and a function of sharing the activities of the social network service (SNS) unit.

The style mirror or smart device includes the display unit and the audio output unit in order that a message which helps the user photographing is output as an image and a voice.

The smart device is selected from among a smartphone, tablet PC, and camera.

The smart device is combined with an angle-adjustable Jabara type holder and then is used with being attached to a typical minor, so that the user's figure reflected in the minor can be photographed as it is in real time regardless of the angle and position.

The style mirror or smart device is a translucent display minor which recognizes the smartphone, i.e., the user terminal, displays another remote smartphone information on the screen by being connected to the above remote smartphone in real time, and interacts with the smartphone on the basis of an Internet of Things (IoT) network.

In the style mirror or smart device, a person and a photographing action are recognized by the proximity sensor. The user's smartphone is recognized by the beacon sensor. User information is transmitted to the server via Wifi or wireless data communication.

The server has a database management and support function of constructing the comprehensive database including the user (member), photo, video, product, and transaction information and of supporting and processing the SNS activities and business transactions of my style client, has a big data collection and analysis function of collecting and analyzing the activities of the social network service (SNS) unit and data related to product search and comment dialog, information sharing, product inquiries, and order payment online activities, which are generated from the business transactions, and has a marketing report issue function of issuing a marketing report which compares a marketing performance with those of similar stores, through a big data analysis material and the analysis of a sales success rate, sales growth rate, average customer transaction, average number of customers, and key transaction details of affiliated stores.

The store terminal includes store information, product information, product inquiry information, mileage and coupon information, and price negotiation and discount related information. Customer-customized promotion is performed.

When the user wears and photographs a product (clothes), an RFID sensing and reading unit of the style mirror system recognizes an RFID attached to the product (clothes), connects with a product database of an internet commerce system of the store, thereby making it possible to pay for and purchase the product by the user's smartphone.

Another embodiment of the present invention which is designed to achieve the above objects of the present invention is a method for executing an application of a mirror capable of sharing photos by bidirectional communication. The method includes: a smartphone recognition step by a beacon sensor, in which, when a person (user) enters a store, a user's smartphone application and a style mirror or a smart device application are driven by a beacon sensor for indoor location tracking, and thus a location of a user terminal (smartphone) and personal information are recognized; a person recognition by a proximity sensor and photographing step in which a photo or video of an action taken by the user who stands before the style mirror or smart device is photographed by an embedded camera while recognizing a situation of the user by a proximity sensor; a photo or video transmission step in which a single or a plurality of the photographed photos or videos are transmitted to a server, a store terminal, and the user terminal (smartphone); an information exchange step through a social network service (SNS) application, in which, after the photo or video is transmitted, the store terminal and the user terminal (smartphone) share, within the server, activities of a social network service (SNS) unit; and a product identification and order step in which, after the information is exchanged, the product is identified through a screen of the smartphone and the product to be purchased is ordered.

The photo or video transmission step includes displaying the photo or video photographed by the camera of the style mirror or smart device, and displaying that the same photo or video is uploaded to the user's smartphone.

### Advantageous Effects

As described above, the mirror system and method which is capable of sharing the photos and videos by bidirectional communication has the following effects.

First, a photo or video of clothes worn by the user, which is obtained by the fact that user's figure reflected in a translucent display mirror capable of interacting with a smartphone on the basis of an Internet of Things (IoT) network is photographed as it is in real time, is transmitted as it is to the smartphone. Also, the clothes product worn by the user can be purchased by the smartphone after the user leaves the store and the store can expect sales from the customer who left the store.

Second, when the user stands before a style mirror or a smart device selected from among the smartphone, tablet PC, and camera, a user's smartphone application and the style mirror or a smart device application are driven by a beacon sensor for indoor location tracking. Natural photographing can be performed according to the user's requests by the style mirror or smart device application.

Third, the photo or video photographed by the camera embedded in the smart device or style mirror is stored in a server and is simultaneously transmitted to a store terminal and the user's smartphone. Photos or videos can be shared through social network services (SNS).

The photographing can be performed according to the user's requests by the combination of the camera, proximity sensor, beacon sensor and by controlling the photo or video photographing moment by a controller.

Fifth, a message which helps the user photographing may be output as an image and a voice by a display unit and an audio output unit within the smart device or style mirror.

Sixth, the smart device is combined with an angle-adjustable Jabara type holder and then is used with being attached to a typical mirror, so that the user's figure reflected in the mirror can be photographed as it is in real time regardless of the angle and position.

Seventh, the present invention has a wide range of application, so that the mirror system and method can be applied to industry fields including clothes or beauty.

### DESCRIPTION OF DRAWINGS

FIG. 1 is a view showing a configuration of a style mirror system capable of sharing photos and videos by bidirectional communication in accordance with an embodiment of the present invention;

FIG. 2 is a view showing a configuration of a smart device attachment type typical mirror system capable of sharing photos and videos by bidirectional communication in accordance with another embodiment of the present invention;

FIG. 3 is a photo view showing appearances of the style mirror when a display of a mirror according to the embodiment of the present invention is turned off and when turned on;

FIG. 4 is a photo view showing a situation where photographing is performed with the smart device attached to a typical mirror in accordance with another embodiment of the present invention;

FIG. 5 is a photo view showing a form of the smart device attached to a typical mirror in accordance with the embodiment of the present invention;

FIG. 6 is a view showing a flow according to the execution of an application of the style mirror capable of sharing photos and videos, by bidirectional communication in accordance with the embodiment of the present invention;

FIG. 7 is a view for describing a process from photo uploading to product order in a mobile manner by executing the application of the style mirror capable of sharing photos and videos, by bidirectional communication in accordance with the embodiment of the present invention;

FIG. 8 is a view showing the entire flow of the application of the style mirror capable of sharing photos and videos by bidirectional communication in accordance with the embodiment of the present invention; and

FIG. 9 is a view showing display information of a store terminal in the configuration of the style mirror system capable of sharing photos and videos by bidirectional communication in accordance with the embodiment of the present invention.

### MODE FOR INVENTION

Hereafter, an exemplary embodiment of the present invention will be described with reference to the accompanying drawings as follows. In the following description, detailed descriptions of technologies and configurations incorporated herein that are well known to those skilled in the art are omitted for the sake of clarity and conciseness. The below-described terms are defined by considering the functions thereof in the present invention and may be changed according to the intention, practice or the like of a user or operator. Therefore, the definitions should be made based on the overall contents of the present specification that describes a mirror system and method which is capable of sharing photos and videos by bidirectional communication.

Hereafter, a style mirror system capable of sharing photos and videos by bidirectional communication in accordance with the exemplary embodiment of the present invention will be described in detail with reference to the accompanying drawings.

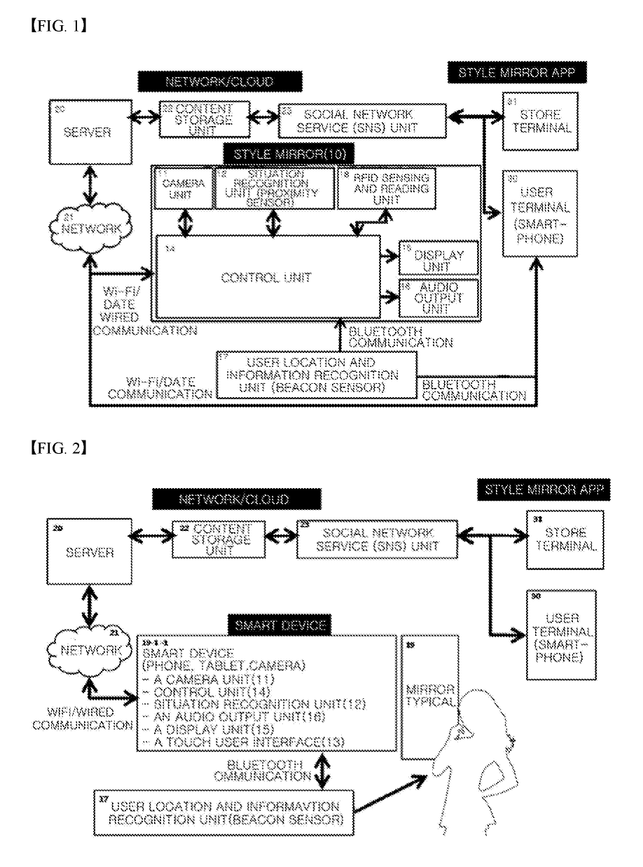

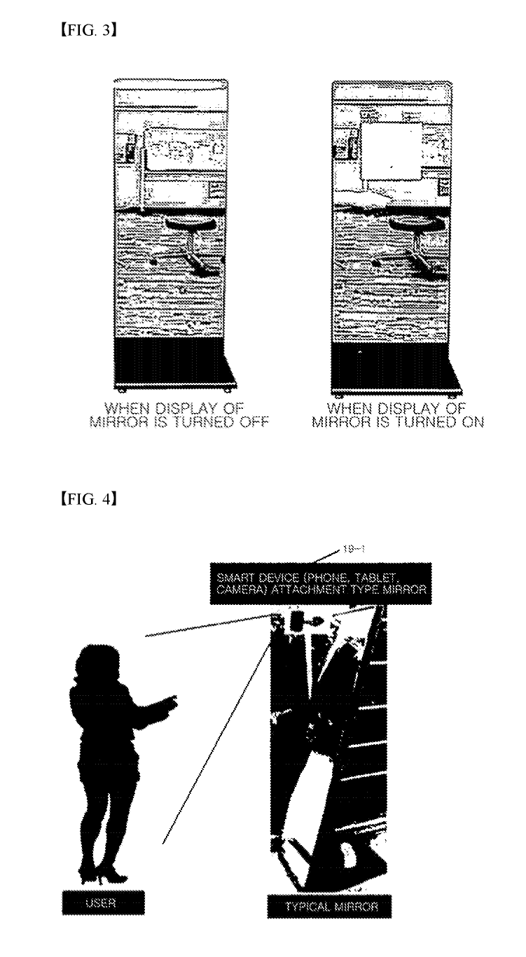

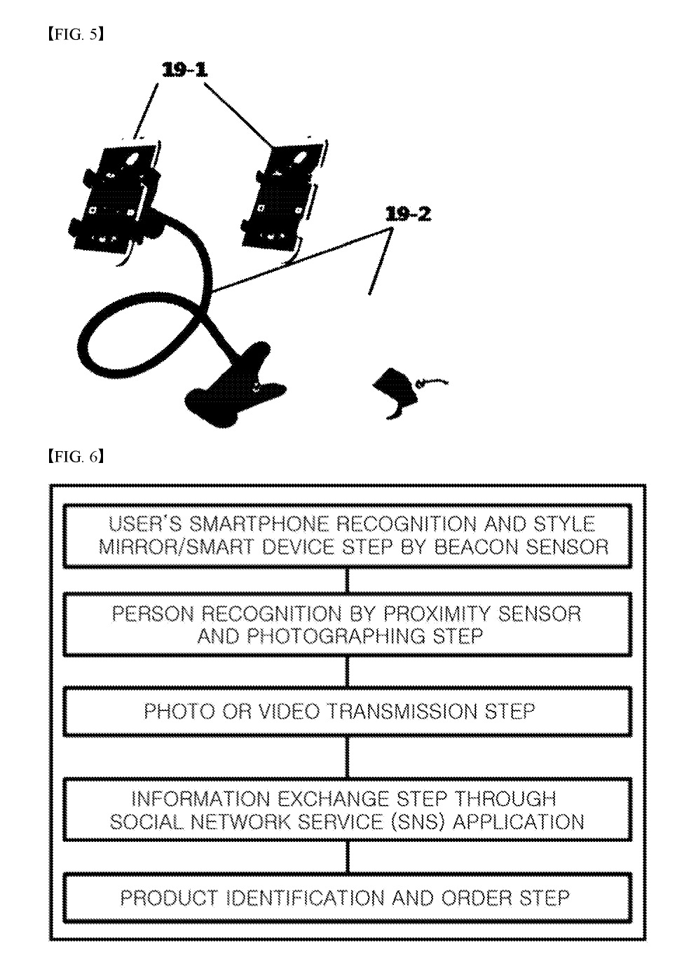

FIG. 1 is a view showing a configuration of the style mirror system capable of sharing photos and videos by bidirectional communication in accordance with an embodiment of the present invention. FIG. 2 is a view showing a configuration of a smart device attachment type typical mirror system capable of sharing photos and videos by bidirectional communication in accordance with another embodiment of the present invention. FIG. 3 is a photo view showing appearances of a style mirror when a display of a mirror according to the embodiment of the present invention is turned off and when turned on. FIG. 4 is a photo view showing a situation where photographing is performed with the smart device attached to a typical mirror in accordance with another embodiment of the present invention. FIG. 5 is a photo view showing a form of the smart device attached to a typical mirror in accordance with the embodiment of the present invention.

As shown in FIGS. 1 to 5, the mirror system capable of sharing photos and videos by bidirectional communication in accordance with the embodiment of the present invention includes: a user location and information recognition unit 17 which has a function of recognizing a user location and personal information by driving a user's smartphone application, a style mirror or a smart device application by a beacon sensor for indoor location tracking; a style mirror 10 or smart device 19-1 which includes: an audio output unit 16 which has a function of broadcasting an execution process of an application of the style mirror or smart device, a situation recognition unit 12 which has a function of recognizing a situation of the user by a proximity sensor after the application is started and has a function of photographing photos or videos, a camera unit 11 which has a function of photographing user's figure by a signal of the situation recognition unit, a display unit 15 which displays the user's figure photographed by the camera unit and an information message on a screen of the smart device or the style mirror, and a control unit 14 which has a function of controlling the operation of the audio output unit, the situation recognition unit, the camera unit, and the display unit and has a function of communicating with the user location and information recognition unit via Bluetooth communication; a network 21 which has a function of connecting a server and the style mirror or smart device via Wifi, wired communication or wireless data communication; a server 20 which includes: a content storage unit 22 which is connected to the style mirror or smart device by the network and has a function of storing contents of an image or video, a social network service (SNS) unit 23 which has a function of sharing the image or video and various activities with a store terminal and a user terminal through social network services (SNS), a function of managing and supporting a comprehensive database including the user, photo, video, product, transaction information, a function of collecting and analyzing the activities of the social network service (SNS) unit and data generated from business transactions, a function of issuing a marketing report, and a function of storing the image or video; a store terminal 31 which has a function of receiving the photo or video stored in the server and a function of sharing the activities of the social network service (SNS) unit; and a user terminal (smartphone) 30 which has a function of receiving the photo or video stored in the server and a function of sharing the activities of the social network service (SNS) unit.

The function of each technical means constituting the mirror system capable of sharing the photos and videos by bidirectional communication in accordance with the embodiment of the present invention will be described as follows.

The user location and information recognition unit 17 has a function of recognizing a user location and personal information by driving the user's smartphone application, style mirror or smart device application by the beacon sensor for indoor location tracking.

The style mirror 10 or smart device 19-1 includes: the audio output unit 16 which has a function of broadcasting an execution process of an application of the style mirror or smart device, the situation recognition unit 12 which has a function of recognizing a situation of the user by a proximity sensor after the application is started and has a function of photographing photos or videos, the camera unit 11 which has a function of photographing user's figure by a signal of the situation recognition unit, the display unit 15 which displays the user's figure photographed by the camera unit and an information message on a screen of the smart device or the style mirror, and the control unit 14 which has a function of controlling the operations of the audio output unit 16, the situation recognition unit 12, the camera unit 11, and the display unit 15 and has a function of communicating with the user location and information recognition unit 17 via Bluetooth communication.

Here, the smart device 19-1 shown in FIGS. 2, 4, and 5 is selected from among the smartphone, tablet PC, and camera. The smart device 19-1 is combined with an angle-adjustable Jabara type holder 19-2 and then is used with being attached to a typical mirror 19, so that the user's figure reflected in the mirror can be photographed as it is in real time regardless of the angle and position.

Also, when the user wears and photographs a product (clothes), an RFID sensing and reading unit 18 of the style mirror system recognizes an RFID attached to the product (clothes), connects with a product database of an internet commerce system of the store, thereby making it possible to pay for and purchase the product by the user's smartphone.

Bluetooth, i.e., a communication method between the user location and information recognition unit 17 and the control unit 14, is an industrial standard for a Personal Area Networks (PANs) and allows various devices to safely communicate with each other at a low cost by using a radio frequency that can be globally used. Bluetooth uses 2.45 GHz of ISM band. Bluetooth versions 1.1 and 2.2 have a speed of 723.1 kbps. Bluetooth version 2.0 features Enhanced Data Rate (EDR), which achieves a speed of 2.1 Mbps. In addition, Bluetooth is a concept which replaces a wired USB, and Wifi is a concept which replaces Ethernet. Secure And Fast Encryption Routine (SAFER) is used in encryption. Pairing by using a keyword is made for the purpose of establishing reliable connection between devices. It may occur that such a process is omitted.

Here, the style mirror 10 is a translucent display mirror which recognizes the smartphone, i.e., the user terminal, displays another remote smartphone information on the screen by being connected to the above remote smartphone in real time, and interacts with the smartphone on the basis of an Internet of Things (IoT) network.

The Internet of Things (IoT) refers to an infrastructure in which all things in the world are connected to each other by the Internet on the basis of information and communication technology (ICT), so that information exchange and communication are made between man and thing and between things. The thing refers to all things that form an environment such as an automobile, various electronic devices, bicycle, glasses, clock, clothes, etc. For this reason, the Internet of Things (IoT) is called a third generation internet beyond the first generation wired Internet and the second generation mobile Internet. In fact, the Internet of Things (IoT) is a technology which has developed steadily in a close relationship with our daily lives rather than a technology which has recently newly emerged.

Also, in the style mirror 10 and smart device 19-1, a person recognition and information recognition during the photographing process are performed by the proximity sensor. The user's smartphone is recognized by the beacon sensor. User information is transmitted to the server 20 via Wifi or wireless data communication.

The network 51 has a function of connecting the server 20 and the style mirror 10 or the smart device 19-1 via Wifi, wired communication or wireless data communication.

The server 20 includes the content storage unit 22 which is connected to the style mirror or smart device by the network and has a function of storing contents of an image or video, and the social network service (SNS) unit 23 which has a function of sharing the image or video and various activities with the store terminal and the user terminal through social network services (SNS). The server 20 has a function of managing and supporting a comprehensive database including the user, photo, video, product, transaction information, a function of collecting and analyzing the activities of the social network service (SNS) unit 23 and data generated from business transactions, a function of issuing a marketing report, and a function of storing the image or video.

Here, the function of the server 20 will be described in detail. The server 20 performs a database management and support function of constructing the comprehensive database including the user (member), photo, video, product, and transaction information and of supporting and processing the SNS activities and business transactions of my style client. The server 20 performs a big data collection and analysis function of collecting and analyzing the activities of the social network service (SNS) unit and data related to product search and comment dialog, information sharing, product inquiries, and order payment online activities, which are generated from the business transactions. The server 20 performs a marketing report issue function of issuing a marketing report which compares a marketing performance with those of similar stores and evaluates the marketing performance through a big data analysis material and the analysis of a sales success rate, sales growth rate, average customer transaction, average number of customers, and key transaction details of affiliated stores, and produces an improvement plan for the sales expansion of the corresponding store.

The store terminal 31 has a function of receiving the photo or video stored in the server 20 and a function of sharing the activities of the social network service (SNS) unit 23.

Here, the store terminal 31 includes store information, product information, product inquiry information, mileage and coupon information, and price negotiation and discount related information, so that customer-customized promotion is performed.

The user terminal (smartphone) has a function of receiving the photo or video stored in the server 20 and a function of sharing the activities of the social network service (SNS) unit 23.

Hereafter, the flow according to the execution of the application of the style mirror capable of sharing the photos and videos by bidirectional communication in accordance with the exemplary embodiment of the present invention will be described in detail with reference to the accompanying drawings.

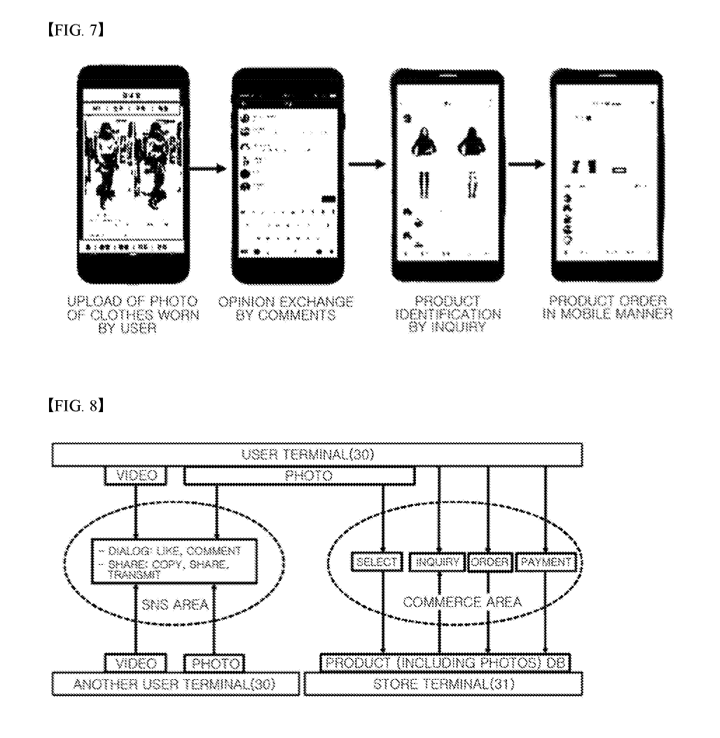

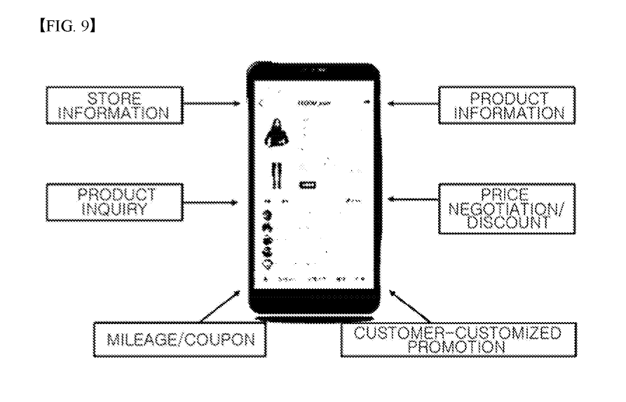

FIG. 6 is a view showing a flow according to the execution of an application of the style mirror capable of sharing photos and videos, by bidirectional communication in accordance with the embodiment of the present invention. FIG. 7 is a view for describing a process from photo uploading to product order in a mobile manner by executing the application of the style mirror capable of sharing photos and videos, by bidirectional communication in accordance with the embodiment of the present invention. FIG. 8 is a view showing the entire flow of the application of the style mirror capable of sharing photos and videos by bidirectional communication in accordance with the embodiment of the present invention. FIG. 9 is a view showing display information of the store terminal in the configuration of the style mirror system capable of sharing photos and videos by bidirectional communication in accordance with the embodiment of the present invention.

As shown in FIGS. 6 to 9, a method for executing the application of the mirror capable of sharing photos and videos by bidirectional communication includes: a smartphone recognition step by the beacon sensor, in which, when the user enters a store, the user's smartphone application and the style mirror or the smart device application are driven by the beacon sensor for indoor location tracking, and thus a location of the user terminal (smartphone) and personal information are recognized; a person recognition by a proximity sensor and photographing step in which a photo or video of an action taken by the user who stands before the style mirror or smart device is photographed by an embedded camera while recognizing a situation of the user by the proximity sensor; a photo or video transmission step in which a single or a plurality of the photographed photos or videos are transmitted to the server 20, the store terminal 31, and the user terminal (smartphone) 30; an information exchange step through a social network service (SNS) application, in which, after the photo or video is transmitted, the store terminal 31 and the user terminal (smartphone) 30 share, within the server 20, activities of the social network service (SNS) unit 23; and a product identification and order step in which, after the information is exchanged, the product is identified through a screen of the smartphone 30 and the product to be purchased is ordered.

The function of each of the technical steps constituting the method for executing the application of the mirror capable of sharing the photos and videos by bidirectional communication in accordance with the embodiment of the present invention will be described as follows.

First, regarding the smartphone recognition step by the beacon sensor, after the user's entry of the store is recognized, the user's smartphone application and the style mirror or the smart device application are driven by the beacon sensor for indoor location tracking, and thus a location of the user terminal (smartphone) and personal information are recognized. For example, an application which identifies an individual who is automatically logged in is displayed on the screen of the smartphone.

Second, regarding the person recognition by a proximity sensor and photographing step, the situation of the user is recognized by the proximity sensor, and a photo or video of the action taken by the user who stands before the style mirror 10 or smart device 19-1 is photographed by the camera 11 embedded in the style mirror 10 or smart device 19-1 by action recognition. For example, it is shown that a young woman is photographed with a stop action in model posture before the mirror.

Third, regarding the photo or video transmission step, a single or a plurality of the photographed photos or videos are transmitted to the server 20, the store terminal 31, and the user terminal (smartphone) 30. Here, the photo or video transmission step includes displaying the photo or video photographed by the camera 11 of the style mirror 10 or smart device 19-1, and displaying that the same photo or video is uploaded to the user's smartphone 30. For example, the photo or video transmission step includes displaying the photo or video photographed by the camera of the style mirror or smart device, and displaying that the same photo or video is uploaded to the user's smartphone.

Fourth, regarding the information exchange step through the social network service (SNS) application, after the photo or video is transmitted, the store terminal 31 and the user terminal (smartphone) 30 share, within the server 20, activities of the social network service (SNS) unit 23. For example, it is shown that two people see the screen of the smartphone.

Fifth, regarding the product identification and order step, after the information is exchanged, the product is identified through the screen of the smartphone 30 and the product to be purchased is ordered.

FIG. 7 is a view for describing a process from photo upload to product order in a mobile manner by executing the application of the style mirror capable of sharing photos and videos, by bidirectional communication in accordance with the embodiment of the present invention. FIG. 7 shows a series of a process comprised of the upload of the photo of the clothes worn by the user, opinion exchange by comments, product identification by inquiry, product order in a mobile manner (smartphone).

FIG. 8 is a view showing the entire flow of the application of the style mirror capable of sharing photos and videos by bidirectional communication according to the embodiment of the present invention.

As shown in FIG. 8, it can be seen between the user terminal 30 and another user terminal 30 that real-time photos or videos and list photos or videos are shared by being viewed, copied, posted on My page, and delivered by the SNS and that the photos or videos are shared by the relationship to post comments and select. Between the user terminal 30 and another user terminal 30, the user is able to view the list photos, to post comments, to select products in a product DB list within the store terminal 31, to inquiry about the product, and to purchase the product through the product order. Also, public relations (PR) can be made through the information of the product DB within the store terminal 31 by the user terminal 30.

FIG. 9 is a view showing display information of the store terminal in the configuration of the style mirror system capable of sharing photos and videos by bidirectional communication in accordance with the embodiment of the present invention. As shown in FIG. 9, the store terminal 31 includes store information, product information, product inquiry information, mileage and coupon information, and price negotiation and discount related information, product order, payment information, and product sending confirmation information, so that customer-customized promotion is performed. Here, the product information is obtained by storing the photos taken by the mirror within the store or the photos taken by the camera in the product DB and by inputting information on the size, price, quantity, and detailed description of the product. The product inquiry means that when the user inquiries about a specific product through the SNS application, not only the information on the corresponding product is provided to the user through the connection to the product DB, but also a reply is given to the user in the form of a comment. The price discount is to provide a reduced price in real time in order to induce the user to purchase a specific product. The product order and payment means that the order contents of the user are checked and the payment is made and then the order history is transmitted to the user terminal. The sending confirmation means that after the ordered product is packaged and delivered to the user, purchase confirmation is requested through the user terminal. The mileage and coupon issue information means that a mileage or coupon is issued through the user terminal where the purchase has been confirmed.

As described above, since various substitutions, modifications, and changes can be made without departing from the technical spirit of the present invention by one of ordinary skill in the art to which the present invention belongs, the present invention is not limited to the above-described embodiments and accompanying drawings.

### INDUSTRIAL APPLICABILITY

As described above, since the mirror system and method which is capable of sharing photos and videos by bidirectional communication can be applied to industry fields including clothes or beauty, the mirror system and method have a wide range of application.

1. A mirror system capable of sharing photos and videos by bidirectional communication, the mirror system comprising:
a user location and information recognition unit which has a function of recognizing a user location and personal information by driving a user's smartphone application, a style mirror or a smart device application by a beacon sensor for indoor location tracking;
a style mirror or smart device which comprises:
an audio output unit which has a function of broadcasting an execution process of an application of the style mirror or smart device,
a situation recognition unit which has a function of recognizing a situation of the user by a proximity sensor after the application is started and has a function of photographing photos or videos,
a camera unit which has a function of photographing user's figure by a signal of the situation recognition unit,
a display unit which displays the user's figure photographed by the camera unit and an information message on a screen of the smart device or the style mirror, and
a control unit which has a function of controlling the operation of the audio output unit, the situation recognition unit, the camera unit, and the display unit and has a function of communicating with the user location and information recognition unit via Bluetooth communication;
a network which has a function of connecting a server and the style mirror or smart device via Wifi, wired communication or wireless data communication;
a server which comprises:
a content storage unit which is connected to the style mirror or smart device by the network and has a function of storing contents of an image or video,
a social network service (SNS) unit which has a function of sharing the image or video and various activities with a store terminal and a user terminal through social network services (SNS),
a function of managing and supporting a comprehensive database comprising the user, photo, video, product, transaction information,
a function of collecting and analyzing the activities of the social network service (SNS) unit and data generated from business transactions,
a function of issuing a marketing report, and
a function of storing the image or video;
a store terminal which has a function of receiving the photo or video stored in the server and a function of sharing the activities of the social network service (SNS) unit; and
a user terminal (smartphone) which has a function of receiving the photo or video stored in the server and a function of sharing the activities of the social network service (SNS) unit.

2. The mirror system of claim 1, wherein the style mirror or smart device comprises the display unit and the audio output unit in order that a message which helps the user photographing is output as an image and a voice.

3. The mirror system of claim 1, wherein the smart device is selected from among a smartphone, tablet PC, and camera.

4. The mirror system of claim 1, wherein the smart device is combined with an angle-adjustable Jabara type holder and then is used with being attached to a typical mirror, so that the user's figure reflected in the mirror is photographed as it is in real time regardless of the angle and position.

5. The mirror system of claim 1, wherein the style mirror or smart device is a translucent display mirror which recognizes the smartphone, i.e., the user terminal, displays another remote smartphone information on the screen by being connected to the above remote smartphone in real time, and interacts with the smartphone on the basis of an Internet of Things (IoT) network.

6. The mirror system of claim 1, wherein, in the style mirror or smart device, a person and a photographing action are sensed by the proximity sensor, wherein the user's smartphone is sensed by the beacon sensor, and wherein user information is transmitted to the server via Wifi or wireless data communication.

7. The mirror system of claim 1, wherein the server
has a database management and support function of constructing the comprehensive database including the user (member), photo, video, product, and transaction information and of supporting and processing the SNS activities and business transactions of my style client,
has a big data collection and analysis function of collecting and analyzing the activities of the social network service (SNS) unit and data related to product search and comment dialog, information sharing, product inquiries, and order payment online activities, which are generated from the business transactions,
and has a marketing report issue function of issuing a marketing report which compares a marketing performance with those of similar stores and evaluates the marketing performance through a big data analysis material and the analysis of a sales success rate, sales growth rate, average customer transaction, average number of customers, and key transaction details of affiliated stores, and produces an improvement plan for a sales expansion of the corresponding store.

8. The mirror system of claim 1, wherein the store terminal comprises store information, product information, product inquiry information, mileage and coupon information, and price negotiation and discount related information, and wherein customer-customized promotion is performed.

9. The mirror system of claim 1, wherein the user wears and photographs a product (clothes), an RFID sensing and reading unit of the style mirror system recognizes an RFID attached to the product (clothes), connects with a product database of an internet commerce system of the store, thereby making it possible to pay for and purchase the product by the user's smartphone.

10. A method for executing an application of a mirror capable of sharing photos and videos by bidirectional communication, the method comprising:
a smartphone recognition step by a beacon sensor, in which, after entry of a person (user) is recognized, a user's smartphone application and a style mirror or a smart device application are driven by a beacon sensor for indoor location tracking, and thus a location of a user terminal (smartphone) and personal information are recognized;
a person recognition by a proximity sensor and photographing step in which a situation of the user is recognized by a proximity sensor, and a photo or video of an action taken by the user who stands before the style mirror or smart device is photographed by a camera embedded in the style mirror or smart device;
a photo or video transmission step in which a single or a plurality of the photographed photos or videos are transmitted to a server, a store terminal, and the user terminal (smartphone);
an information exchange step through a social network service (SNS) application, in which, after the photo or video is transmitted, the store terminal and the user terminal (smartphone) share, within the server, activities of a social network service (SNS) unit; and
a product identification and order step in which, after the information is exchanged, a product is identified through a screen of the smartphone and the product to be purchased is ordered.

11. The method of claim 10, wherein the photo or video transmission step comprises displaying the photo or video photographed by the camera of the style mirror or smart device, and displaying that the same photo or video is uploaded to the user's smartphone.
